(19) United States
(12) Patent Application Publication
(10) Pub. No.: US 2006/0185020 A1
(43) Pub. Date: Aug. 17, 2006

(54) Software piracy protection device

(75) Inventor: Itzhak Levy, Hollywood, FL (US)

Correspondence Address: LERNER GREENBERG STEMER LLP, P O BOX 2480, HOLLYWOOD, FL, 33022-2480, US

(73) Assignee: IDE Technologies, Inc.

(21) Appl. No.: 11/058,989

(22) Filed: Feb. 16, 2005

(51) Int. Cl. H04L 9/32

(52) U.S. Cl. 726/27

(57) ABSTRACT

A software piracy protection and access authorization device is provided in the form of a USB dongle key. A first end is formed with a USB connector for insertion into a USB port receptacle in a computer device. A second end is formed with a USB port receptacle for receiving a USB connector of a peripheral device to be connected to the computer device. Piracy protection and access authorization software is operatively connected to the first end that plugs into the computer device. The second end is connected to the first end to enable an operative USB connection between the peripheral device and the computer device. The peripheral connection may be entirely transparent, i.e., completely independent of the piracy protection and access authorization software, or it may be a protected connection that is partly or wholly directed through the piracy protection and access authorization software.

### BACKGROUND OF THE INVENTION

### Field of the Invention

The invention lies in the computer technology field. More specifically, the invention relates to a software piracy protection device for the computer software industry.

Software piracy is a ubiquitous issue in the computer industry. A consumer can purchase a single copy of a given software package and then duplicate the software into unlimited copies and distribute them all over the world for a significant reduction in sale price. Not only do software vendors lose considerable revenue, it is entirely possible that unauthorized users of the duplicated software may contact vendors with technical support issues, causing the vendors additional loss of time and money.

Governments all over the world acknowledge the impact of software piracy on the computer industry and try to protect vendors' intellectual property with international treaties, laws and more severe penalties for infringement of the copyright and the intellectual property rights of software vendors. It is not enough to rely on the government to protect vendors' intellectual property rights. Vendors take every possible step to decrease the incidence of software piracy.

The piracy problem has created a niche for a new industry of license and software protection devices to emerge and to be successfully combat the piracy problem.

Some of the most common methods of software protection developed to date are as follows:
Floating License.
Soft License.
Web Base Activation License.
The Dongle Key License.

The Floating License is a soft license with an algorithm code generated for a particular computer system, using one or more of the computer's components as the license verification element. For example, the floating license can be linked to the serial number or the volume number of the computer's hard disk. If the hard disk is replaced by another hard disk or if the user attempts to install the software on another computer system, the software application will advise the user that the license is invalid and will discontinue the installation.

The Soft License is a code number encrypted in the software that must be entered by the user during installation in order to activate the software. If the user does not have the matching code, installation will not continue. The limitation of this license from the vendor's standpoint is that the user can still copy the software and give the code to as many unauthorized users as he wishes.

The Web Based Activation License was developed in response to the security limitation of the Soft License. Software vendors created a system that would require the user to log into a website or obtain a license code online during installation. Additional installations of the software could be monitored and denied by the vendor.

One of the common problems with the floating and the web based activation licenses is that often the user may replace his computer system or experience a system crash requiring system rebuilding. In either case, the user must contact the software vendor and request a new license. One of the limitations of the soft and web based licenses from a user standpoint is that the license is bound to a specific computer and can not be used with any other computer without first obtaining a new license from the vendor. For example, a business user purchases an expensive software package and installs it on the desktop computer in his office. In order to work on his laptop at home, he must first contact the vendor and obtain a new license which is likely to be refused. Such a limitation would discourage the user from purchasing software from a vendor employing floating or web based activation licenses.

The other common type of software license is the dongle key. The dongle key is an external device that connects to a computer system's parallel port. The protected software application monitor's the parallel port for the presence of the dongle key. The software will run and execute as expected as long as the dongle key is connected to the parallel port. If the dongle key is removed, the protected software will discontinue execution and will give the user an invalid license message. The dongle key allows the user to run the application on any other computer system as long as he moves the dongle to the other computer system. The only limitation from the user's standpoint is that the software can run only at one computer system at any given time. From the vendor's and user's standpoint, the dongle key license is the best solution to the problem of software piracy.

The use of the parallel dongle key is very popular and is used by many software venders to protect their intellectual property. However, the computer industry is a rapidly changing industry. Many new computers have replaced the larger parallel port with the more compact USB connector interface. The disappearance of the parallel port is rapidly making the parallel dongle key obsolete. In order to continue using the more advantageous dongle key license, software vendors will require a dongle key that can operate using the USB or any other available port on the computer (i.e., firewire, serial ATA, etc.).

More and more manufacturers of computer peripheral devices are abandoning support for the standard peripheral connection to the computer system (i.e., parallel port, add-on card, IDE bus) and using the USB interface as their first choice due to the ease and simplicity of connection. The USB connection has become the most popular form of connection for peripheral devices. As a result, users require several USB ports per computer in order to meet the demand for peripheral attachments such as: printers, scanners, keyboards, mice, digital cameras, external disks, tape drives, etc.

### SUMMARY OF THE INVENTION

It is accordingly an object of the invention to provide a software piracy protection device, which overcomes the above-mentioned disadvantages of the heretofore-known devices and methods of this general type.

The object is achieved by providing a pass-through USB dongle key that will include access authorization (e.g., license number, access ID) provided by the software vendor but still allow the user to connect a peripheral device via the pass-through USB dongle key.

With the foregoing and other objects in view there is provided, in accordance with the invention, a software piracy protection and access authorization device, comprising:

a first end forming a USB connector for insertion into a USB port receptacle in a computer device;

a second end forming a USB port receptacle for receiving a USB connector of a peripheral device to be connected to the computer device; and

piracy protection and access authorization code or hardware operatively connected to the first end forming the USB connector, and the second end being connected to the first end to enable an operative USB connection between the peripheral device and the computer device.

The term “code” as used herein encompasses both software and hardware implementations, as well as any intermediate solutions.

In accordance with an added feature of the invention, the first end and the second end are disposed and connected in a rigid dongle.

In accordance with an additional feature of the invention, the first end and the second end are connected via a cable and the piracy protection and access authorization code is contained in the first end or in the second end, or in the pass-through USB dongle.

In accordance with another feature of the invention, the first end is connected to the second end via a buffer, electronic switch, or logic to render the device transparent to the peripheral device. In the alternative, the piracy protection and access authorization code contains selective access software for the peripheral device.

The novel device allows software vendors to protect their intellectual property with a pass-through USB dongle key connected to one of the computer's USB ports and while allowing the user to make use of the same USB port for any other peripheral device required.

The invention has several advantages. For example, inter alia, the invention
eliminates the need for a parallel port;
frees the USB port for other use while protecting the vendors' rights;
can easily be moved between computer systems; and
is small and easy to carry (i.e., it can be attached to the user's key chain).

As such, the novel device also has considerable utility as a computer system access authorization key.

The term “dongle” as used herein describes an electronic device that must be attached to a computer in order for certain protected software to run. It also encompasses a system authorization key, network access authorization key, and personal ID.

Other features which are considered as characteristic for the invention are set forth in the appended claims.

Although the invention is illustrated and described herein as embodied in a software piracy protection device, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a plan view of a prior art parallel dongle;

FIG. 2 is a diagrammatic view of a prior art system with a computer system with one parallel port and one USB port;

FIG. 3A is a partly schematic view of a USB dongle key according to the invention, incorporating the novel pass-through feature;

FIG. 3B is a plan view of a USB dongle key according to the invention without the pass-through feature;

FIG. 4 is a diagrammatic view of a modern prior art computer system with four separate devices requiring a USB port; and

FIG. 5 is a similar view of such a system with the novel USB dongle key with the pass-through feature.

### DESCRIPTION OF THE PREFERRED EMBODIMENTS

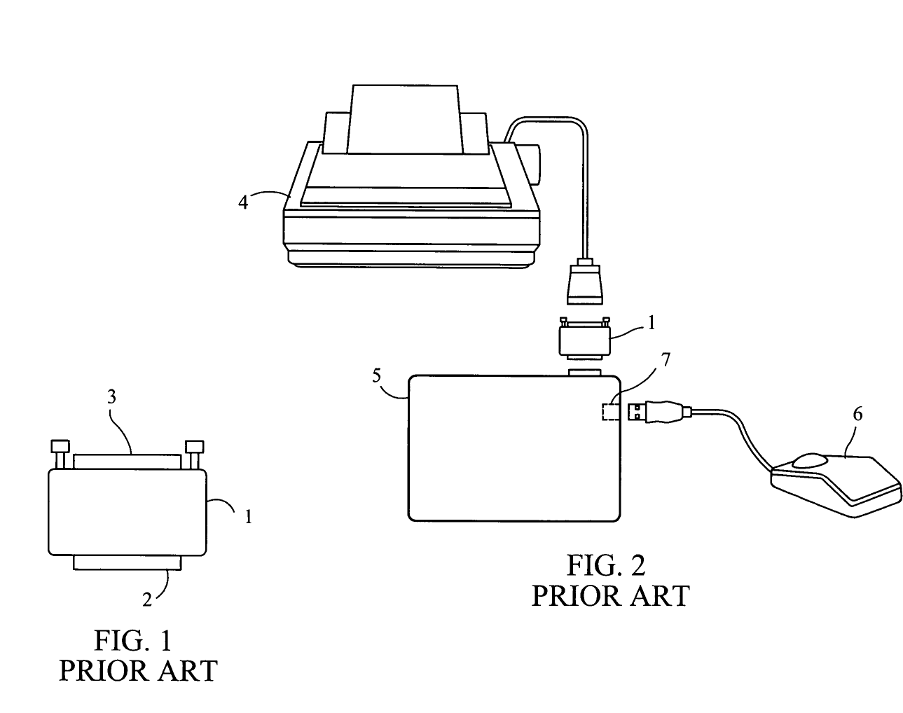

Referring now to the figures of the drawing in detail and first, particularly, to FIGS. 1 and 2 thereof, a parallel dongle 1 has a male connector side 2 with 25 pins and a female connector side 3 with 25 correspondingly arranged plug openings. By the nature of the dongle 1, the pins at the male connector side 2 are not simply straight-through connected to the female connector side 3. Instead, the dongle 1 has interior code and/or cross-over connections that misalign the connectors of one side to those of the other side. The dongle 1 is connected as an insert between a parallel port of a computer 5 and a peripheral device, such as the illustrated parallel printer 4.

The computer 5 also has a USB mouse 6 connected via a USB port 7.

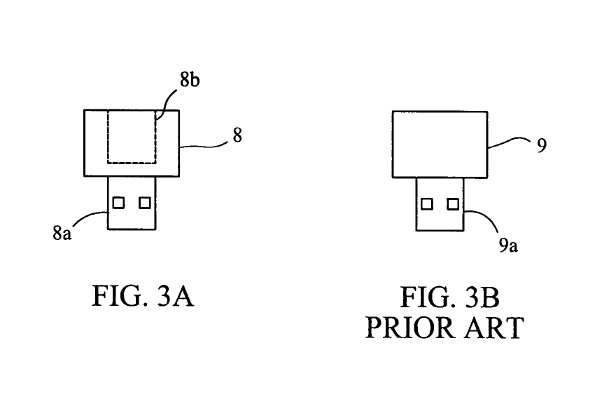

Referring now to FIG. 3A, there is shown a novel pass-through USB dongle 8. A male plug side 8A is configured to be connected to a computer USB port 7 of a computer and the other side, a female plug side 8B, will allow the connection of any peripheral with a USB connector.

FIG. 3B illustrates a prior art embodiment of a USB dongle 9. Such a dongle is available, by way of example, from Matrixlock of Germany (www.matrixlock.de). The dongle 9 that will connect to one of the USB ports 7 without allowing a peripheral to be connected via the dongle. The dongle 9 contains the internal software protection and license authorization. This dongle 9, then, is an access authorization key which may be assigned a person, a department, a licensed user of a certain software program, etc. When it is plugged in, one of the USB ports is lost and, if the additional port is required, the user is required to attach a USB multiplier or USB extension.

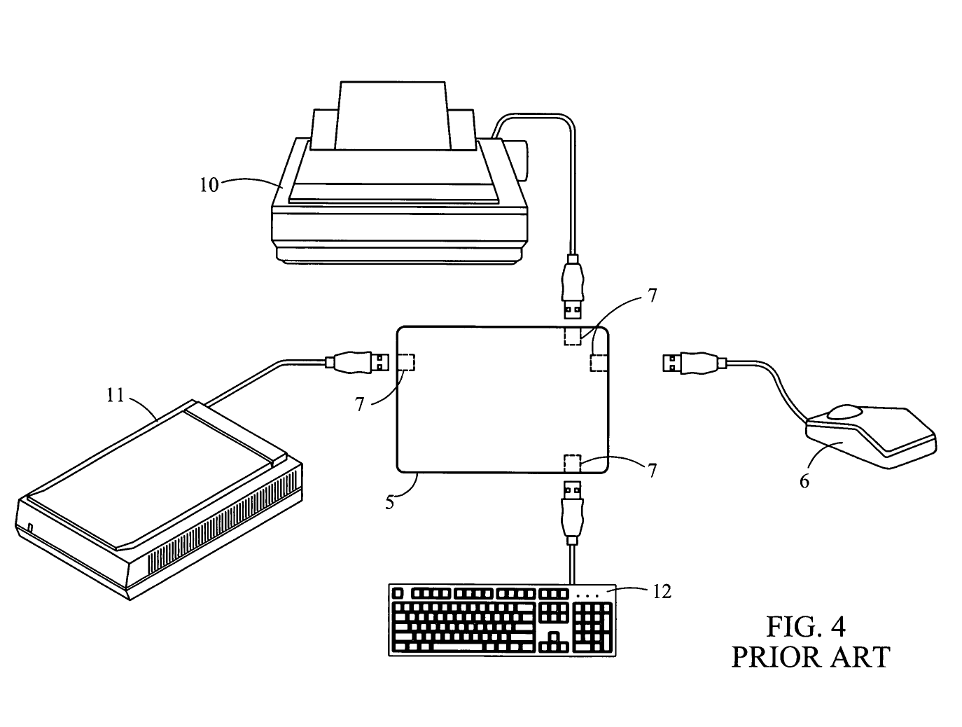

FIG. 4 shows computer system 5 with four USB ports 7 that allow the connections of the parallel printer 10, scanner 11, keyboard 12, and a mouse 6. Here, a typical situation arises, namely, that all of the available USB ports are used up by the peripherals. Should the user wish to connect the software protection or access protection dongle without the above-noted pass-through feature, one of the USB ports would be lost and one of the devices would have to be unplugged, or an expensive port extension would have to be installed.

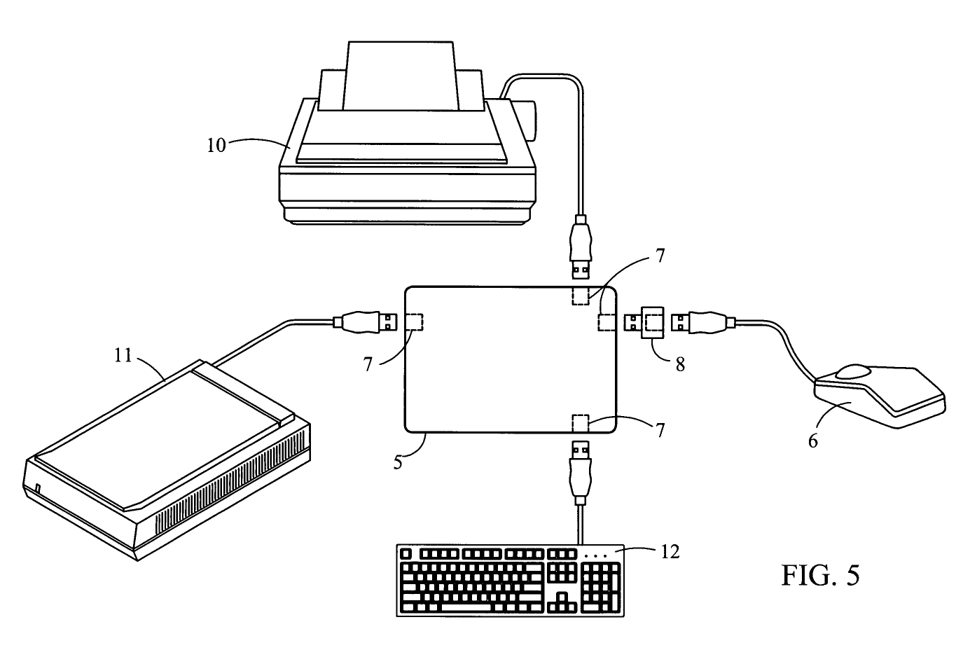

FIG. 5 illustrates an advantage to be obtained with the pass-through feature. Here, the computer system 5 again has four USB ports 7 that allow the connections of the parallel printer 10, scanner 11, keyboard 12, and a mouse 6. In addition, the dongle 8, i.e., the pass-through USB device 8, has been connected inline with one of the peripherals. This figure points out the importance of the USB ports and the fact that they all may be needed ay the same time. In this case the pass-through USB dongle 8 may play a very imported role if the computer does not have enough USB ports 7 to support all needed peripherals and in the same time a software piracy dongle device needs to be used to enable a given software application.

I claim:

1. A software piracy protection and access authorization device, comprising:
a first end forming a USB connector for insertion into a USB port receptacle in a computer device;
a second end forming a USB port receptacle for receiving a USB connector of a peripheral device to be connected to the computer device; and
piracy protection and access authorization code or hardware operatively connected to said first end forming the USB connector, and said second end being connected to said first end to enable an operative USB connection between the peripheral device and the computer device.

2. The device according to claim 1, wherein said first end and said second end are disposed and connected in a rigid dongle.

3. The device according to claim 1, wherein said first end and said second end are connected via a cable and said piracy protection and access authorization code is contained in said first end or in said second end.

4. The device according to claim 1, wherein said first end is connected to said second end to render the device transparent to the peripheral device.

5. The device according to claim 1, wherein said piracy protection and access authorization software contains selective access code for the peripheral device.

6. The device according to claim 1, wherein a connection between said first end and said second end bypasses the piracy protection and access authorization code but includes cross-over connections between said first end and said second end.
